(19) United States
(12) Patent Application Publication
(10) Pub. No.: US 2007/0036636 A1
(43) Pub. Date: Feb. 15, 2007

(54) Book-making equipment and a book-making method using the same

(76) Inventor: Hitoshi Takahashi, Aichi (JP)

Correspondence Address: MORGAN LEWIS & BOCKIUS LLP, 1111 PENNSYLVANIA AVENUE NW, WASHINGTON, DC, 20004, US

(21) Appl. No.: 10/563,963

(22) PCT Filed: Jul. 11, 2003
(86) PCT No.: PCT/JP03/08877

§ 371 Date: Aug. 4, 2006

(51) Int. Cl. B42C 9/00

(52) U.S. Cl. 412/9

(57) ABSTRACT

In a book-making equipment (1) in which laminated sheet papers (10) permit one elevational end side to be bonded on a work table to produce a booklet. The laminated sheet papers (10) are thrown into a hollow space between pressure surfaces (20) with the book-making equipment (1) stood on the work table. The laminated sheet papers (10) thus thrown into the hollow space, permit the one elevational end side or other end side to be trued up with the one elevational end side extended beyond the pressure surfaces (20) by a predetermined length. The laminated sheet papers (10) permit the one elevational end side to be clamped with the clutch pieces 2 stably stood on the work table. This makes it ready to bond the one elevational end side of the laminated sheet papers (10), and eliminating the necessity of the time-consuming labor and the special skill with a good appearance and bonding strength insured in the booklet.

### FIELD OF THE INVENTION

The present invention relates to a book-making equipment provided to bond one elevational end of laminated sheet papers so as to produce a booklet, and also concerns to a book-making method using the book-making equipment.

### BACKGROUND OF THE INVENTION

Recently, there have been opportunities to publish a small number of booklets (several tens of volumes or less) in academic seminars, individual activities and hobby circles with the spread of word processors and copy machines.

Upon producing booklets, it is possible to bind laminated sheet papers with staplers or binder tapes if no regard is given to their outer appearances. If ordered to book binder manufacturers, the cost to have the booklets bound per unit becomes higher even if finished good with their outer appearances because the volumes of the booklets are limited.

In Japanese Utility Model Publication No. 7-26134, a book binder tool is introduced in which a sheet folder is used to fasten the book papers by threads so as to produce a gorgeous book. It takes the special skill and the time-consuming labor to fold sheets in two and bind the laminated sheet papers with the threads. This is not appropriate for unskilled users to utilize in such opportunities as to publish books for individuals interested in the common subjects.

The Japanese Utility Model Publication No. 7-26134 discloses an auxiliary plate or a clamp plate in its drawings which is adapted to engage with an entire surface of the laminated sheet papers except for a shelfback to which an adhesive is applied. Although this prevents the laminated sheet papers from getting loose, the clamp plate exerts pressure against the laminated sheet papers, thus making it difficult to true up the elevational side end of the laminated sheet papers. In order to true up the elevational side end of the laminated sheet papers, it is necessary to sever the elevational end so as not to lose its good appearance after the laminated sheet papers is bound.

In the Japanese Utility Model Publication No. 7-26134, the structure is that the shelfback side of the sheet papers terminates short of pressure surfaces of the auxiliary plate or the clamp plate when using the sheet papers smaller than a predetermined size. This makes it difficult to bind the shelfback side of the sheet papers.

Upon using the sheet papers larger than the predetermined size, the shelfback side extends farther beyond the pressure surfaces of the auxiliary plate or the clamp plate. This makes it unable to stably bind the shelfback side of the laminated sheet papers.

Therefore, it is an object of the invention to overcome the above drawbacks, and provide a book-making equipment and a book-making method which is capable of neatly making an elevational end uniform without severing it, and enabling even unskilled users to readily fasten the laminated sheet papers regardless of whether the sheet papers are folded double or threads are used.

It is also an object of the invention to provide a book-making equipment and a book-making method which is capable of neatly making an elevational end uniform when using sheet papers having a size other than a predetermined scale.

### DISCLOSURE OF THE INVENTION

[Invention of Claim 1]

According to the invention of claim 1, a pair of clutch pieces are placed perpendicular to a work table. Clutch pieces have the corresponding planar pressure surfaces provided to releasably hold one elevational end of the laminated sheet papers between the clutch pieces. A pushing member trues up the one elevational end or the other elevational end of said laminated sheet papers, and pushes the one elevational end out of the pressure surfaces. A clamping member is provided to adjustably decrease a space between the pressure surfaces so as to clamp the one elevational end of the laminated sheet papers in such a direction as to depress the laminated sheet papers.

Such is the structure that the one elevational end or the other end of laminated sheet papers is made even, and the one elevational end is clamped stably on the work table with the one elevational end extended beyond the pressure surfaces by the predetermined length. This makes it possible to bond the laminated sheet papers regardless of whether or not the sheet papers are folded double. This obviates the necessity of the special skill and the time-consuming labor with a good appearance and bonding strength insured upon bonding the laminated sheet papers.

Loosening the clamping member increases the space between the pressure surfaces, thus making it possible to take the laminated sheet papers out of the pressure surfaces and truing up the laminated sheet papers.

The slack-prevention member engages with the laminated sheet papers so as to avoid the laminated sheet papers from getting loose.

In general, the laminated sheet papers are liable to weigh down under the influence of gravity and get loosened when trying to make the laminated sheet papers stand on the shelfback portion or the belly portion against the surface of the work table. This necessiates to rectify the loosened portion after placing the laminated sheet papers between the pressure surfaces.

The structure, however, makes it possible to directly clamp the laminated sheet papers only after placing the laminated sheet papers between the pressure surfaces. This advantage is especially useful when truing up the shelfback portion in which most of the laminated sheet papers except for the shelfback portion are located above the pressure surfaces.

The slack-prevention member avoids the laminated sheet papers from getting loose because the slack-prevention member engages with one portion of the laminated sheet papers except for the one elevational end of the laminated sheet papers. This engenders portions in which the slack-prevention member does not engage among the other end or the elevational end of the laminated sheet papers. For this reason, it enables the users to tap or push the other end or the elevational end which is included in the other portion or the elevational end portion of the laminated sheet papers.

Despite the slack-prevention member is provided, it is possible to make the laminated sheet papers uniform by exerting the force against the elevational end or the other end of the laminated sheet papers. This advantage is particularly useful when changing sizes of the laminated sheet papers. Because it enables the user to true up the laminated sheet papers by tapping or pushing the elevational end of or the other end of the laminated sheet papers (referred to FIGS. 3, 4(a) and 10).

[Invention of Claim 2]

According to the invention of claim 2, a side-triming member is provided to engage with an elevational end side formed between the one elevational end and other elevational end of the laminated sheet papers so as to confine the laminated sheet papers to true up the elevational end side of the laminated sheet papers. Tihs makes it possible to ease the work to align the elevational side of the laminated papers with good appearance after throwing the laminated papers between the pressure surfaces.

[Invention of Claim 3]

According to the invention of claim 3, an extension adjustment member is provided to adjust a distance between the pressure surfaces and the surface of the work table, or to adjust a distance between the one elevational end of the laminated sheet papers and the surface of the work table so as to determine a length in which the one elevational end of the laminated sheet papers extends out of the pressure surfaces.

This makes it possible to adjust the extended length depending on the bonding strength, the thickness of the laminated sheet papers, characteristics of the laminated sheet papers and the adhesive used.

[Invention of Claim 4]

According to the invention of claim 4, a sheet-size alteration member is provided to adjust a distance between the one elevational end of the laminated sheet papers and the surface of the work table so as to produce booklets of different sizes.

This makes it possible to bond not only the booklet of the predetermined size (e.g., A4 vertically bound size) but also the booklet of other sizes (e.g., A5, B5 vertically bound size) with a single one book-making equipment.

[Invention of Claim 5]

According to the invention of claim 5, a main support member has a main step portion provided to make the clutch pieces stand on the surface of the work table. A movable piece is supported by the main support member and adapted to move toward and away from the main support member upon adjusting the space between the pressure surfaces.

With the above structure, it is possible to clamp the elevational end of the laminated sheet papers with the clutch pieces stood on the work table.

[Invention of Claim 6]

According to the invention of claim 6, the main step portion extends toward and away from the movable piece of the main support member as defined by L/H≧1/20. Where L is a distance in which the main step portion extends away from the movable piece, and H is a height of the book-making equipment.

This makes it possible to maintain the book-making equipment standing on the work table, while at the same time, clamping the laminated sheet papers or doing other jobs on the work table.

[Invention of Claim 7]

According to the invention of claim 7, it is possible to provide a book-making equipment which has all the advantages which claims 1-6 can offer.

[Invention of Claim 8]

According to the invention of claim 8, after roughening an elevational surface of the one elevational end extended beyond the pressure surfaces by means of a specified tool, an adhesive is applied to the roughened elevational surface to bond the one elevational end of the laminated sheet papers. This makes it possible to firmly bond the paper sheets of the laminated sheet papers through the adhesive.

[Invention of Claim 9]

According to the invention of claim 9, the roughened elevational surface is tapped to permeate the adhesive between the laminated sheet papers after the adhesive is applied to the roughened elevational surface. This makes it possible to deeply permeate the adhesive between the laminated sheet papers so as to increase the bonding strength between the laminated sheet papers.

[Invention of Claim 10]

According to the invention of claim 10, the one elevational end of the laminated sheet papers is clamped in such a direction as to depress the laminated sheet papers with the adhesive left in half-dried condition.

With the above method, it is possible to appropriately reduce the thickness of the elevational end swollen due to the adhesive applied to it, while at the same time, increasing the bonding strength of the elevational end of the laminated sheet papers.

### BRIEF DESCRIPTION OF THE DRAWINGS

Preferred forms of the present invention are illustrated in the accompanying drawings in which:

FIG. 1 is a perspective view of a book-making equipment according to an embodiment of the present invention;

FIG. 2 is an exploded perspective view of the book-making equipment;

FIG. 3 is a perspective view showing how to true up a belly portion of a booklet with a spacer inserted into the book-making equipment;

FIG. 4(a) is a left elevational side view of the book-making equipment upon using a sheet-size alteration member;

FIG. 4(b) is a perspective view of the spacer;

FIG. 5(a) is a left elevational side view of the book-making equipment upon using an extension adjusting member;

FIG. 5(b) is a perspective view of an underside of the spacer;

FIG. 6 is a perspective view of the book-making equipment when forming grooves on a spinal end side of laminated sheet papers;

FIG. 7 is a perspective view of the book-making equipment when applying an adhesive to a spinal end side of the laminated sheet papers;

FIG. 8(a) is a perspective view of the book-making equipment in which an elevational end of the laminated sheet papers is clamped with the adhesive left in half-dried condition;

FIG. 8(b) is a perspective view of pressure surfaces with the laminated sheet papers clamped therebetween;

FIG. 9(a) is a perspective view of the booklet in which a divider draws lines on the spinal end side of the laminated sheet papers;

FIG. 9(b) is a perspective view of the booklet in which the divider measures a thickness of the elevational end of the laminated papers;

FIG. 10 is a perspective view of the book-making equipment inverted to true up the elevational end of the laminated papers;

FIG. 11 is a perspective view of the book-making equipment angularly turned by 90 degrees to bond the laminated papers;

FIG. 12(a) is a perspective view of the book-making equipment in which the spinal end side of the laminated sheet papers is roughened by means of an abrasive tool;

FIG. 12(b) is an enlarged perspective view in which the spinal end side of the laminated sheet papers is roughened;

FIG. 13 is a perspective view of the laminated sheet papers divided into several volumes after applying the adhesive to the spinal end side of the laminated sheet papers;

FIG. 14 is a perspective view of a modification form of the book-making equipment;

FIG. 15 is a perspective view of other modification form of the book-making equipment; and

FIG. 16 is a perspective view of a modified clamping member.

### BEST MODES TO CARRY OUT THE EMBODIMENTS OF THE INVENTION

### EMBODIMENTS OF THE INVENTION

[Structure of the Invention]

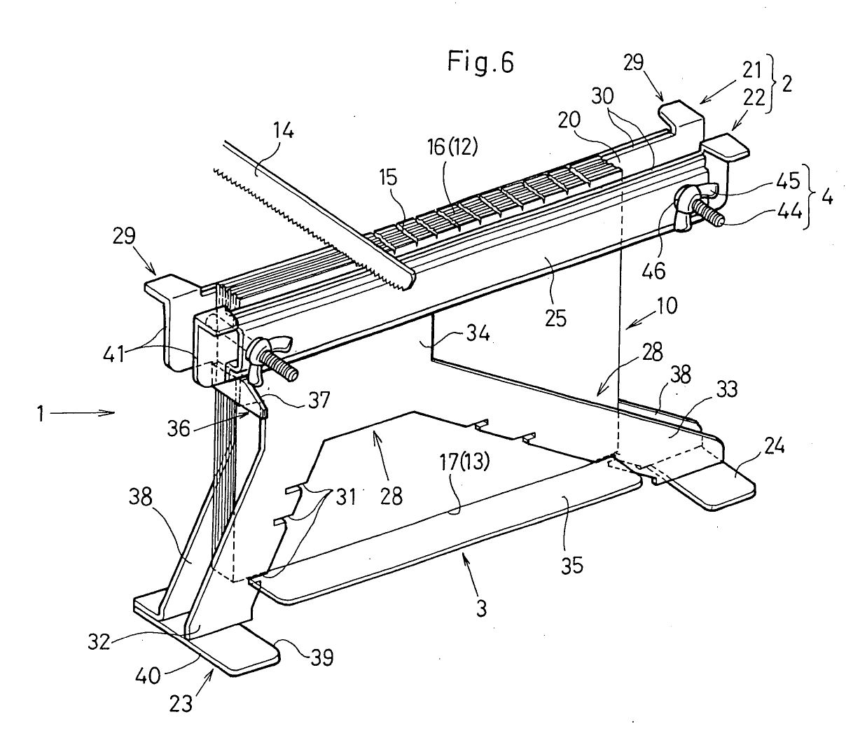

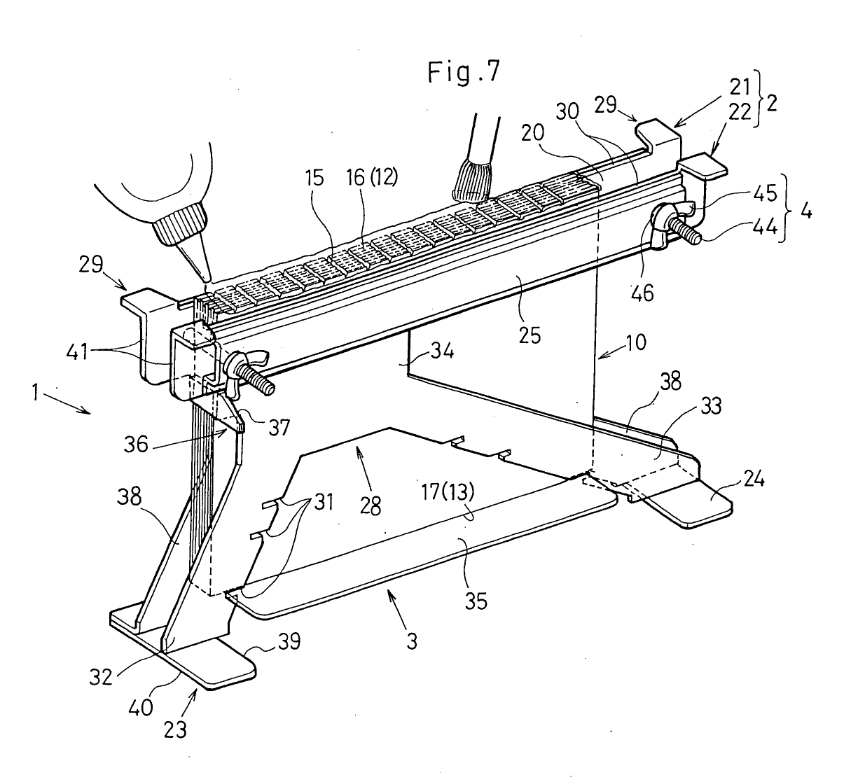

A book-making equipment 1 is a mechanical tool to produce a booklet by bonding an elevational end of laminated sheet papers 10 in which a plurality of sheet papers are laminated. The elevational end of the laminated sheet papers 10 is to be bonded with an adhesive or the equivalent to form a spinal end side 12 to which a shelfback sheet 11 is adhered as shown in FIGS. 6-9. Other end sides of the laminated sheet papers 10 are free from the adhesive and referred to a spread sheet side in which a belly end side 13 is formed. A spinal side 16 is an integral part of the spinal end side 12, and provided with grooves 15 defined by means of a serrated rasp 14 provided as an abrasive tool. A belly side 17 is an integral part of the belly end side 13 to form the spread sheet side. A divider 18 is used as a special tool to adhere the shelfback sheet 11 to the spinal side 16.

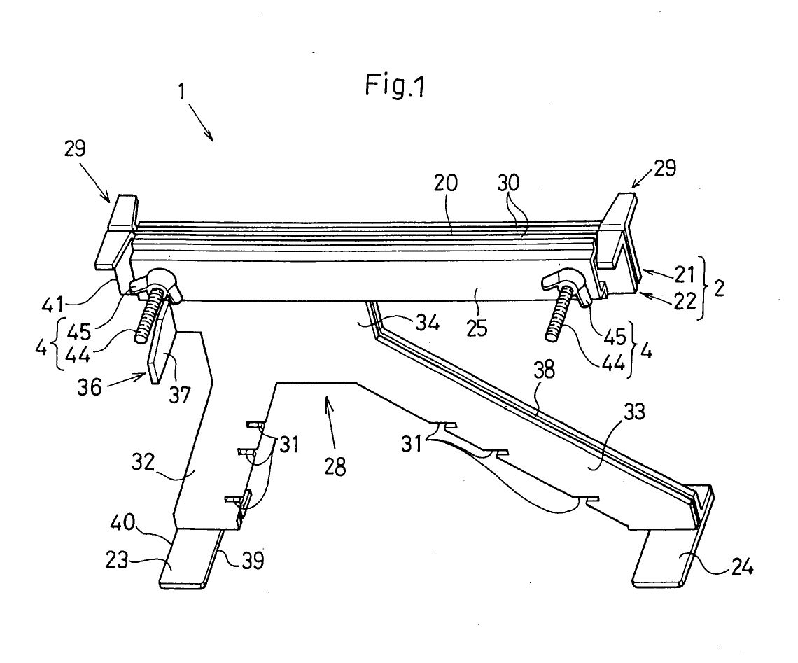

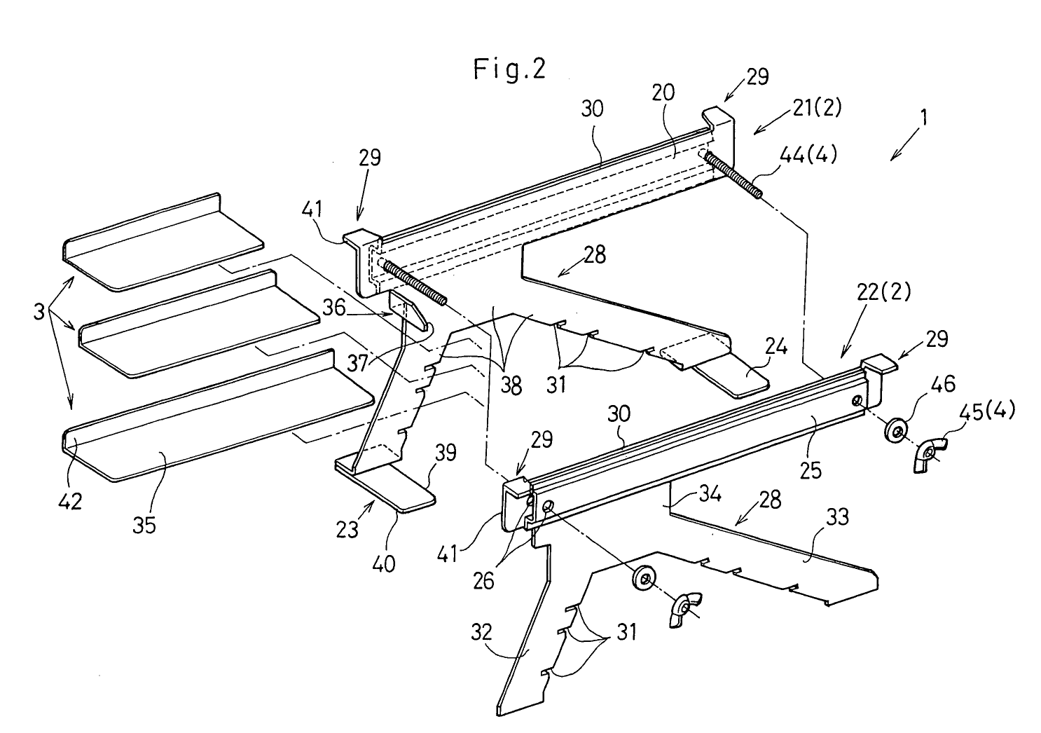

The book-making equipment 1 has a pair of clutch pieces 2 to clutch the spinal end side 12 of the laminated sheet papers 10 by means of pressure surfaces 20 as shown in FIGS. 1 and 2. In the book-making equipment 1, spacers 3 are provided independent of the clutch pieces 2 to form a part of a pushing member. A clamping member 4 is provided to clamp the spinal end side 12 in such a direction as to depress the laminated sheet papers 10. The pushing member is an instrument used to push the spinal end side 12 beyond the pressure surfaces 20 by a predetermined length when applying the rasp and the adhesive to the spinal end side 12.

The clutch pieces 2 has a main support member 21 and a movable member 22, while at the same time, the clutch pieces 2 have main step portions 23, 24 directly placed perpendicular to a surface of a work table (not shown). The movable member 22 is indirectly placed perpendicular to the surface of the work table because the movable member 22 is supported by the main support member 21 through the clamping member 4. The movable member 22 is adapted to move toward and away from the main support member 21 so as to adjustably increase and decrease a hollow space between the pressure surfaces 20.

The clutch pieces 2 have the pressure surfaces 20 to clutch the spinal end side 12 of the laminated sheet papers 10, and having a leg portion forming an integral part of the pushing member so as to place the clutch pieces 2 perpendicular to the surface of the work table. The clutch pieces 2 may be formed out of various materials including wooden blocks, metal plates or synthetics.

The pressure surfaces 20 has a planar inclination to extend in parallel with the surface of the work table when the book-making equipment 1 is placed on the work table (referred hereinafter to as a “horizontal direction” which is in parallel with the surface of the work table). The pressure surfaces 20 form a sash-like configuration, and having a width dimension extending perpendicular to the surface of the work table (referred hereinafter to a “vertical direction” which is perpendicular to the surface of the work table). The pressure surfaces 20 are provided with an inner side of the main support member 21 and the movable member 22 in a mutually opposed relationship as shown in FIG. 2.

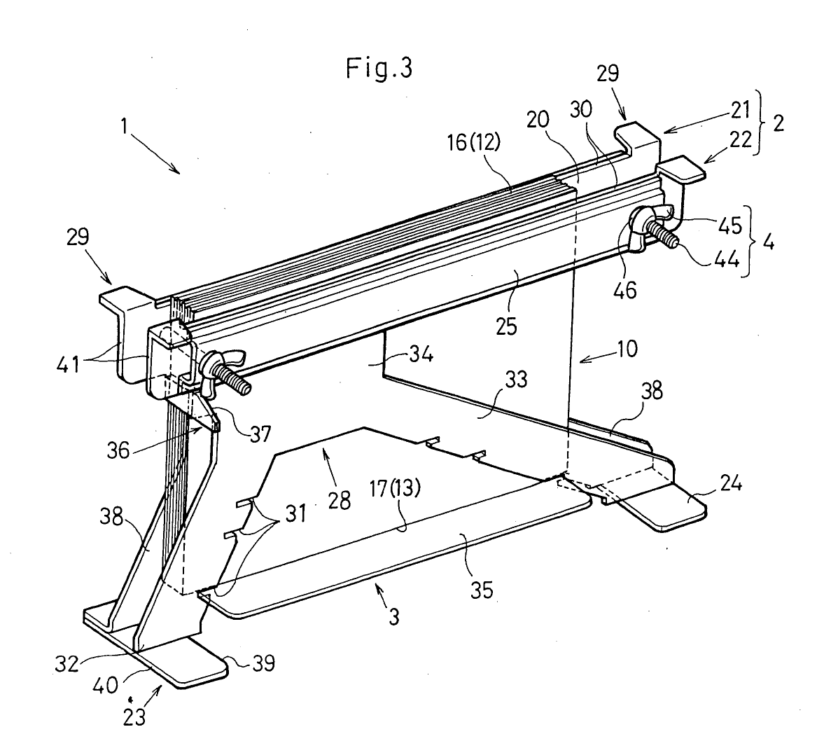

When the spinal end side 12 of the laminated sheet papers 10 is thrown into the hollow space between the pressure surfaces 20 as shown in FIGS. 3-5, the clamping member 4 squeezes the hollow space to clamp the spinal end in such a direction to depress the laminated sheet papers 10.

A sash-like plate 25 is provided as a reinforcement to compensate the strength of the pressure surfaces 20. The plate 25 is generally formed angular in cross section so as to provide a space with elevational sides of the pressure surfaces 20. The sash-like plate 25 is such that it reinforces the pressure surfaces 20 to absorb stresses applied to the pressure surfaces 20, thus protecting the pressure surfaces 20 against the bending deformation, cracks and injuries which would be otherwise occurred.

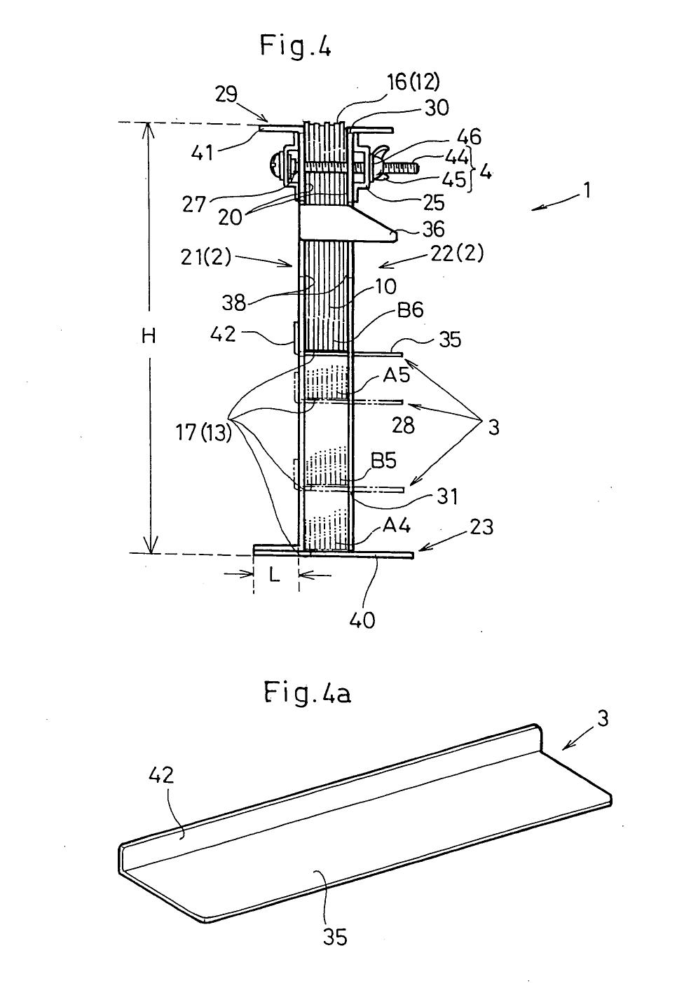

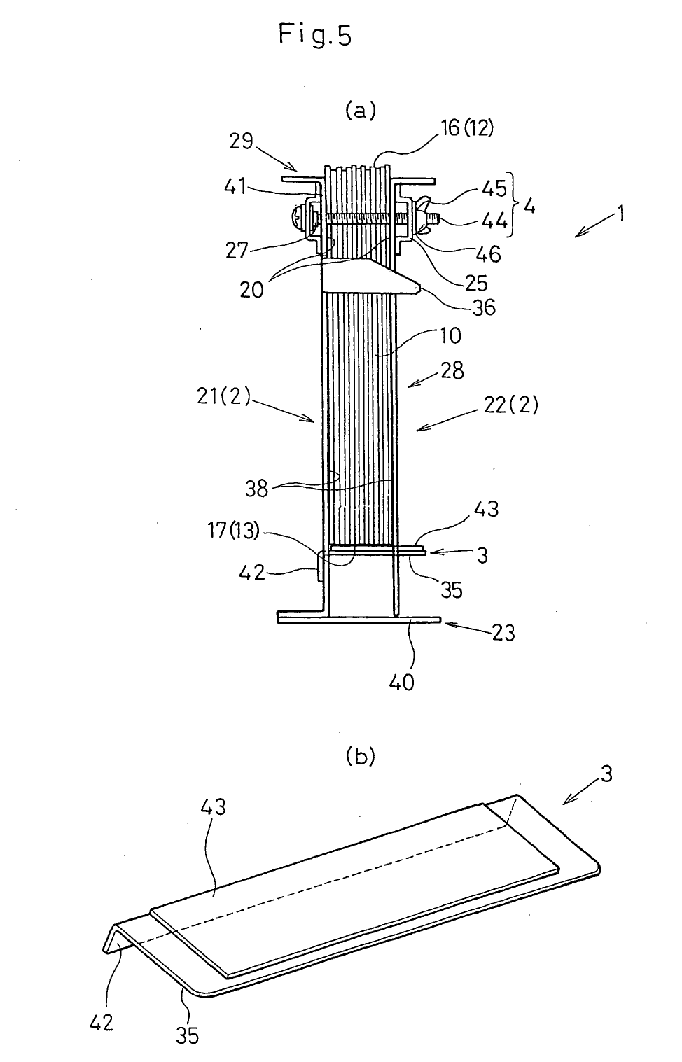

At both ends of the sash-like plate 25 and the pressure surfaces 20, a passage hole 26 is pierced, through which the clamping member 4 passes perpendicular to the pressure surfaces 20. The sash-like plate 25 of the main support member 21 has a flange 27 formed within the space by means of a burring procedure as shown in FIGS. 4(a) and 5(a). In order to be in communication with the passage hole 26, the flange 27 has a screw hole (not shown) in which the clamping member 4 is tightened.

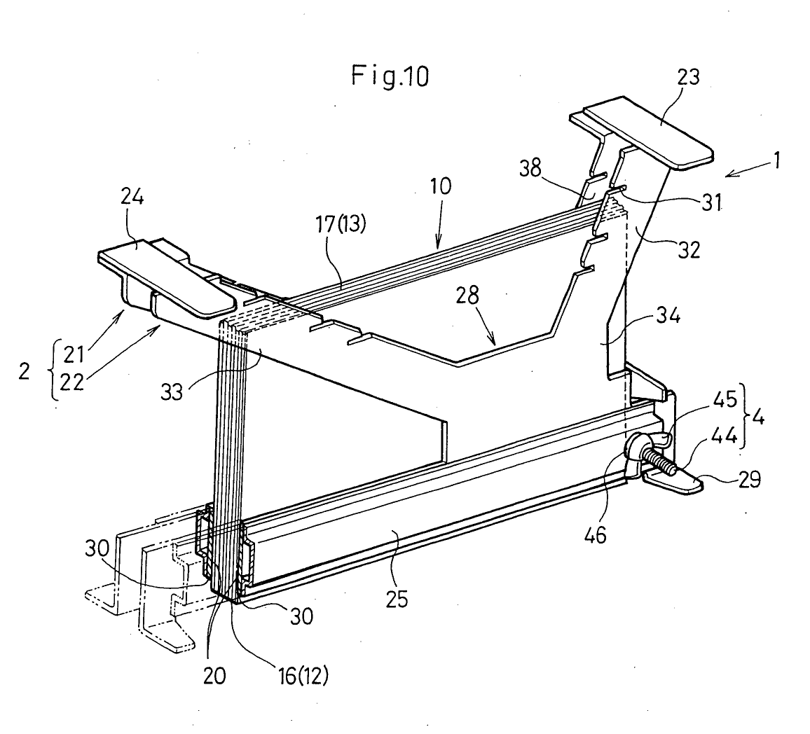

As shown in FIGS. 3-5, the leg portion has a main leg piece 28 provided to stand on the surface of the work table upon truing up the belly end side 13 of the laminated sheet papers 10. The leg portion further has an auxiliary leg piece 29 provided to stand on the surface of the work table upon truing up the spinal end side 12 of the laminated sheet papers 10 as shown in FIG. 10.

The main leg piece 28 extends vertically from a lower edge of the pressure surfaces 20 at the main support member 21 and the movable member 22. The main leg piece 28 of the main support member 21 and the main leg piece 28 of the movable member 22 are opposed each-other to be paired piece plates. The structural situation permits a predetermined distance between the pressure surfaces 20 and the surface of the work table so as to make the main leg piece 28 serves as the pushing member when the clutch piece 2 is placed on the surface of the work table.

The main leg piece 28 enables a user to push the spinal end side 12 of the laminated sheet papers 10 (A-4 vertical binding size) out of an upper edge of the pressure surfaces 20 by a predetermined length. An edge of the pressure surfaces 20, from which the spinal end side 12 extends is referred hereinafter to as an “extension edge 30”. A dimensional length of the spinal end side 12, from which the extension edge 30 projects is referred hereinafter to as an “extension length”.

A “vertical binding size” is defined herein with a longer side of the laminated sheet papers aligned along the spinal side 12 and the belly end side 13. A “lateral binding size” is defined herein with a shorter side of the laminated sheet papers aligned along the spinal side 12 and the belly end side 13. In this situation, the belly side 17 is placed on the surface of the work table to true up the belly end side 13 of the laminated sheet papers 10.

The main leg piece 28 has a short branch 32 and a long branch 33 each having lateral notches 31 into which the spacer 3 is selectively inserted as shown in FIGS. 1-3. Between the short branch 32, the long branch 33 and a vertical lower edge of the pressure surface 20, a connection piece 34 is provided. In order to stably stand the clutch piece 2 on the work table, a main step pieces 23, 24 are provided at a lower end of the short branch 32 and the long branch 33 in the main support member 21. The short branch 32 and the long branch 33 are extension pieces bifurcated at the connection piece 34 in the main support member 21 and the movable member 22.

The connection piece 34 is horizontally placed partially at one end of the pressure surfaces 20 so that the main support member 21 and the movable member 22 are determined to be of different lengths. Namely, the short branch 32 extends toward one horizontal end side of the pressure surfaces 20, and the long branch 33 extends horizontally toward the other end side of the pressure surfaces 20. One end of the pressure surfaces 20 is referred hereinafter to as a “left end side”, and the other end of the pressure surfaces 20 is referred to as a “right end side”. This arrangement gradually diverges a horizontal distance between the short branch 32 and the long branch 33 as vertically approaching downward.

Each inner side of the short branch 32 and the long branch 33 has a plurality of the lateral notches 31 at different levels in the main support member 21 and the movable member 22. The lateral notches 31 in the same level are opposed each other to form paired pieces in the main support member 21 and the movable member 22.

As shown in FIGS. 2-4, the corresponding spacers 3 are adapted to be inserted into the opposed notches 31 in the same direction as the clamping member 4 clamps. The paired notches 31 are positioned in such a level as to hold the extension length in correspondence to the vertical binding size (A4, B5, A5, B6) as shown in FIG. 4.

In this sense, the lateral notches 31 form a sheet-size alteration member. The sheet-size alteration member enables the user to produce booklets of different sizes by changing a distance between the surface of the work table and the belly end side 13 of the laminated sheet papers 10 thrown between the pressure surfaces 20. Namely, this is done in an aim to insure the individual extension lengths by inserting the corresponding spacers 3 into the paired notches 31 in different levels.

In this instance, the laminated sheet papers 10 moves its belly side 17 to encounter a belly-side trimming portion 35 provided with the individual spacers 3 to true up the belly end side 13 of the laminated sheet papers 10. The connection piece 34 extends from a lower edge of the left end side of the pressure surfaces 20 in the main support member 21 and the movable member 22. The connection piece 34 of the main support member 21 and the connection piece 34 of the movable member 22 are opposed to form a paired pieces. The connection piece 34 of the main support member 21 has a lug portion 36 protracted from the left end side in the direction perpendicular to the pressure surfaces 20. The lug portion 36 has a right side surface extending in the direction perpendicular to the surface of the work table so as to form a side-end trimming portion 37.

The side-end trimming portion 37 brings the lug portion 36 into engagement with an elevational side of the laminated sheet papers 10 resided between the spinal end side 12 and belly end side of the laminated sheet papers 10. The side-end trimming portion 37 is such that the lug portion 36 restricts the laminated sheet papers 10 at its movement in the right-and-left direction so as to true up an elevational end including the elevational side of the laminated sheet papers 10 as shown in FIGS. 3 and 4.

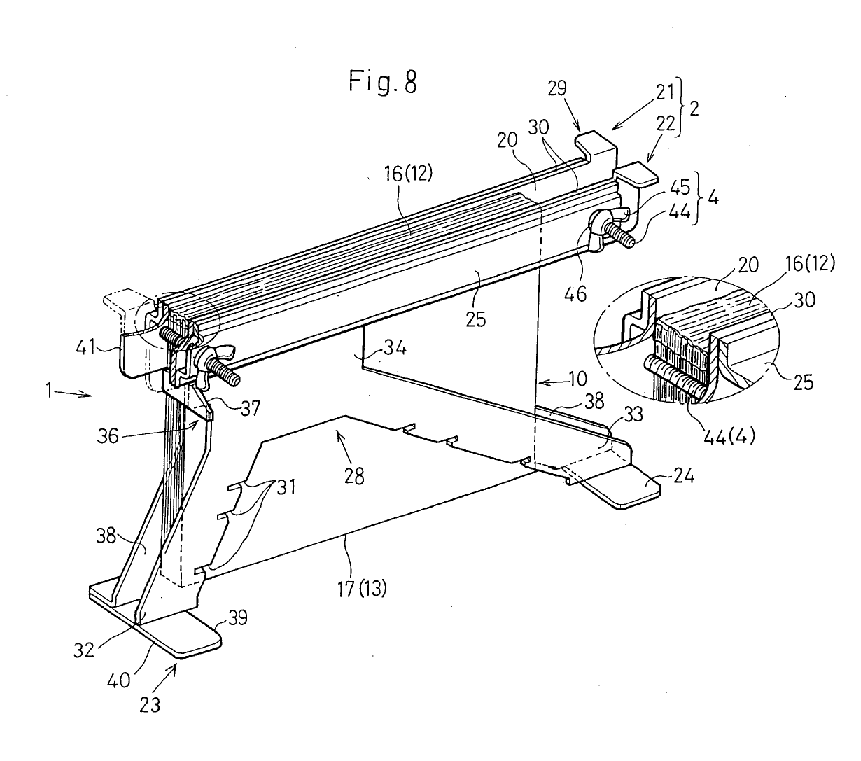

In this instance, the laminated sheet papers 10 are placed at its left elevational side to rest on the lug portion 36 so as to true up a left elevational end including its left elevational side of the laminated sheet papers 10. The lug portion 36 is placed closer to the right side of the pressure surfaces 20 than the passage hole 26 is located. This arrangement permits the lug portion 36 to true up the left elevational end of the laminated sheet papers 10 without stereoscopically interferring the clamping member 4 as shown in FIGS. 8(a) and 8(b).

The short branch 32, the long branch 33 and the connection piece 34 are in coplanar relationship with the pressure surfaces 20, and having an abutment surface 38 which engages with an unspecified area of the laminated sheet papers 10 except for its spinal end side 12. The abutment surface 38 of the main support member 21 and the abutment surface 38 of the movable member 22 are opposed to form paired surfaces so as to clutch the unspecified area of the laminated sheet papers 10 other than its spinal end side 12.

The abutment surface 38 forms a slack-prevention member provided to engage with the unspecified area of the laminated sheet papers 10 other than its spinal end side 12, thus preventing the laminated sheet papers 10 from getting loose when it is thrown between the pressure surfaces 20.

The abutment surface 38 is figured in accordance with the short branch 32, the long branch 33 and the connection piece 34. Namely, the abutment surface 38 has a width in the right-and-left direction, and extends downward from the lower edge closer to the left end side of the pressure surfaces 20 with a predetermined height until radially bifurcated in the right and left directions. The structure is such that a distance between the two branches 32, 33 progressively increases in the right and left directions as approaching downward.

In this way, the abutment surface 38 is brought into engagement with the radiallly bifurcated area of the laminated sheet papers 10 other than its spinal end side 12, thus preventing the laminated sheet papers 10 from getting loose.

With the abutment surface 38 formed into the radially bifurcated configuration, it is possible to form the slack-prevention member with less amount of material. Due to a vertical space appeared between the pressure surfaces 20 and the long branch 33, it is possible to push and tap the right elevational end of the laminated sheet papers 10 through the vertical open space when the size-of the laminated sheet papers 10 is replaced with a smaller one. Namely, the abutment surface 38 permits a pushing force to exert against the right elevational end of the laminated sheet papers 10 so as to neatly true up its right elevational end.

Upon truing up the spinal end side 12 of the laminated sheet papers 10 as shown in FIG. 10, the laminated sheet papers 10 are liable to get loose under the influence of the weight because a majority of the laminated sheet papers 10 except for its spinal end side 12 are located above the pressure surfaces 20. In this situation, the abutment surface 38 can work effectively in preventing the laminated sheet papers 10 from sagging.

Upon truing up the spinal end side 12, the laminated sheet papers 10 brings the belly side 17 to direct upward. The radially bifurcated area of the abutment surface 38 permits the user to push and tap the belly side 17 of the laminated sheet papers 10 so as to true up the spinal end side 12 all the more neatly.

In the meanwhile, the main step portions 23, 24 are provided with a lower end of the short branch 32 and the long branch 33 in the main support member 21 as shown in FIG. 2. The main step portions 23, 24 extend toward and away from the movable member 22 of the main support member 21, and having flat surfaces come in contact with the surface of the work table.

In order to stably stand the clutch piece 2 on the work table, a relationship between a length (L) and a height (H) is defined as follows:
L/H≧1/2

Where, the length (L) is a horizontal extension away from the movable member 22, and the height (H) is a vertical extension of the book-making equipment 1 as shown in FIG. 4(a).

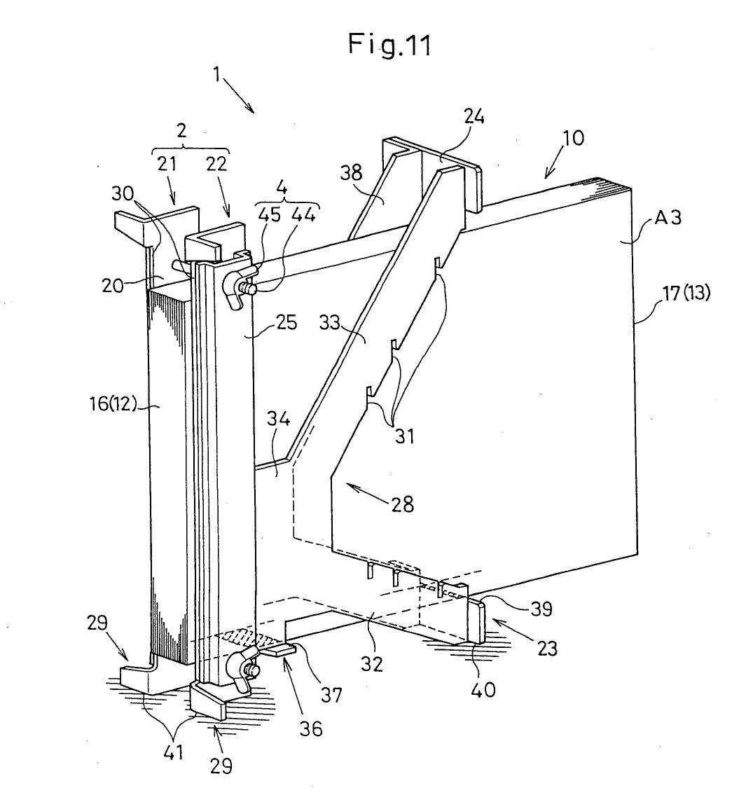

The main step piece 23 of the short branch 32 has a right side edge 39 to true up the elevational end of the laminated sheet papers 10 in cooperation with the side-end trimming portion 37. Namely, the main step piece 23 permits its right side edge 39 to true up a lower side end of the laminated sheet papers 10 together with the side-end trimming portion 37 when angularly turned by 90 degrees as shown in FIG. 11.

The main step piece 23 also permits its left side edge 40 to help maintain the clutch piece 2 upright on the surface of the work table. Namely, the main step piece 23 permits its left side edge 40 and a left side end 41 of the pressure surfaces 20 to come in contact with the surface of the work table as shown in FIG. 11. This makes it possible to bond larger laminated sheet papers (e.g., A3 lateral binding size) upon producing the booklet.

The auxiliary leg pieces 29 are parts of the pressure surfaces 20, and extend from both ends of the extension edge 30 outside the main support member 21 and the movable member 22. The auxiliary leg pieces 29 vertically extend first, and then turns at right angles away each other to protract in the opposite direction so as to form a flat surface in parallel with the surface of the work table. The auxiliary leg pieces 29 engage their flat surface with the work table upon standing the clutch pieces 2 invertedly on the work table as shown in FIG. 10. This enables the user to stably hold the clutch pieces 2 invertedly, while at the same time, providing a certain distance between the extension edge 30 and the surface of the work table.

For this reason, the auxiliary leg pieces 29 permits the spinal side 16 of the laminated sheet papers 10 to protract out of the extension edge 30 as the pushing member, and makes the spinal side 16 engage with the work table to true up the spinal end side 12 of the laminated sheet papers 10.

When using the auxiliary leg pieces 29 as the pushing member, it is possible to true up the spinal end side 12 of the laminated sheet papers 10 of different sizes without using the sheet-size alteration member.

In this situation, it is also possible to exert a pushing force against the right and left elevational sides of the laminated sheet papers 10 so as to neatly true up its right and left elevational ends. The auxiliary leg pieces 29 further have a left side edge 41 to hold the clutch pieces 2 stood invertedly when angularly turned by 90 degrees as shown in FIG. 11.

The spacers 3 are instruments to push the spinal end side of the laminated sheet papers 10 out of the extension edge 30 by the predetermined length, while at the same time, truing up the belly end side 13 of the laminated sheet papers 10 as shown in FIGS. 3 and 4(a),(b).

The three spacers 3 prepared in the present embodiment correspond to the laminated sheet papers of different sizes (e.g., B5, A5, B6 lateral binding sizes). These three spacers 3 are of different lengths, and adapted to be inserted into the corresponding lateral notches 31 as the sheet-size alteration member. This makes it possible to produce the booklet of different sizes even when the bifurcated abutment surface 38 gradually diverges the short branch 32 and the long branch 33 to enlarge the distance therebetween. The spacers 3 may be formed from various sorts of materials such as a metallic plate, wooden plate or synthetic plate.

As shown in FIG. 4(b), the spacers 3 have rectangular plates, each of which is bent at right angles upward along the longitudinal side, and divided into a vertical side and a horizontal side situated in parallel with the surface of the work table. As shown in FIG. 4(a), each of the spacers 3 arranges an upper surface of the horizontal side to receive the belly side 17 of the laminated sheet papers 10 so as to true up its belly end side 13.

Each of the spacers 3 arranges an inner side surface of the vertical side to serve as a stopper 42 which engages with the abutment surface 38 upon inserting the spacer 3 into the corresponding notches 31. With an underside of the horizontal side of the spacer 3, there is provided a thickness-uniform plate 43 except for right and left sides of the spacer 3 because its right and left sides engage with the lateral notches 31. The thin plate 43 serves as an extension adjustment member which adjusts a distance between the spinal end side 12 of the laminated sheet papers 10 and the surface of the work table so as to adjustably arrange the extension length.

In this instance, the spacer 3 is turned upside down before inserted into the lateral notches 31 to set the thin plate 43 upward so as to adjustably increase the extension length as shown in FIGS. 5(a),(b). Upon adjusting the extension length, the thin plate 43 receives the belly side 17 to true up the belly end side 13 of the laminated sheet papers 10.

Upon using thick sheet papers or determining the bonding strength to be greater, it is possible to permeate the adhesive deeply between the laminated sheet papers 10 by increasing the extension length.

The clamping member 4 adjustably decreases the hollow space between the pressure surfaces 20 and squeeze the spinal end side 12 of the laminated sheet papers 10 in such a direction as to depress the laminated sheet papers 10. The clamping member 4 has a screw 44 tightened into the screw hole of the flange 27 through the passage hole 26, and having a wing nut 45 attached to the jutted end of the screw 44. Between the wing nut 45 and the clutch piece 2, a washer 46 is provided. By tightening the wing nut 45 against the clutch piece 2 through the washer 46 to move the movable member 22 toward the main support member 21, it is possible to squeeze the hollow space between the pressure surfaces 20 to clamp the spinal end side 12 of the laminated sheet papers 10.

[Book-Making Method According to the Present Structure]

The following are processes described to show how to bond the laminated sheet papers 10 according to the present invention.

Upon truing up the belly end side 13 of the laminated sheet papers 10, main step portions 23, 24 are brought to come in contact with the surface of the work table so as to vertically stand the book-making equipment 1 on the work table as shown in FIGS. 3, 4(a),(b) and 5.

After selecting the spacer 3 in correspondence to the size of the laminated sheet papers, while at the same time, deciding whether or not the spacer 3 is to turn upside down, the wing nut 45 is loosened to spread the hollow space between the pressure surfaces 20 into which the laminated sheet papers 10 are thrown as shown in FIG. 3.

The laminated sheet papers 10 permits the belly side 17 to encounter the belly-side trimming portion 35 to true up its belly end side 13 when deciding the belly-side trimming portion 35 to direct upward. By slightly pushing the right elevational side to engage the left elevational side against the side-end trimming portion 37, thus restricting the laminated sheet papers 10 at its movement to true up the left elevational end of the laminated sheet papers 10. By tapping the spinal side 16 and the right elevational side to give the vibration, it is possible to true up the laminated sheet papers 10 all the more neatly.

Then, the wing nut 45 is tightened to decrease the hollow space between the pressure surfaces 20 so as to clamp the spinal end side 12 with the spinal end side 12 protracted upward from the extension edge 30 by the predetermined length.

As shown in FIG. 6, the serrated file 14 is used to form grooves 15 (approx. 1 mm in depth) on the spinal side 16 of the spinal end side 12 with regular intervals (approx. 1 cm). This produces a roughened (ruffled) surface on the spinal side 16. In so doing, the adhesive is applied to the spinal side 16 so as to be extensively daubed over the spinal side 16 with the use of the toothpick, the chopstick or the swab.

By tapping the spinal side 16 to which the adhesive is applied, it is possible to deeply permeate the adhesive between the laminated sheet papers 10 before leaving the adhesive in half-dried condition. When made in-haste, it is possible to half dry the adhesive by blowing hot air against the spinal side 16 of the laminated sheet papers 10. It is preferable that the adhesive is made of an aqua-dissoluble substance such as vinyl-acetate based synthetics.

As shown in FIGS. 8(a) and 8(b), the laminated sheet papers 10 are pulled inside the pressure surfaces 20 through the spinal end side 12 upon loosening the wing nut 45. After loosening the wing nut 45, the wing nut 45 is tightened again in such a direction as to depress the laminated sheet papers 10. This makes it possible to return the bloated spinal end side 12 of the laminated sheet papers 10 to the original thickness even after the spinal end side 12 is bloated due to the adhesive applied to it.

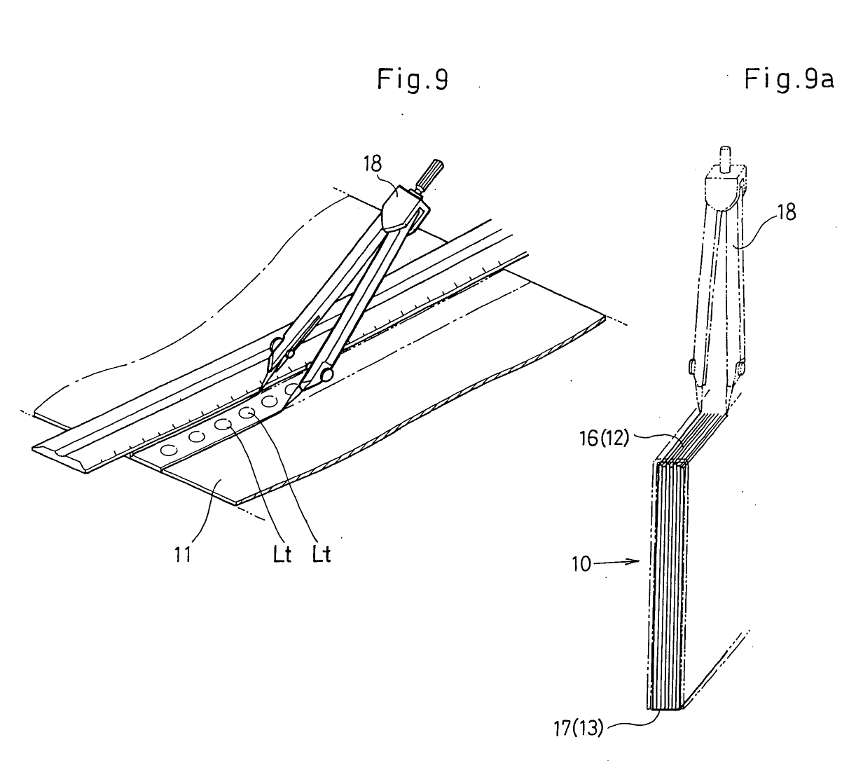

Upon attaching the shelfback sheet 11 to the spinal end side 12 as shown in FIGS. 9(a) and 9(b), the thickness of the spinal end side 12 is measured with the use of a divider 18 after the adhesive is applied to the spinal end side 12 as shown in FIG. 9(b). Lines are drawn by the divider 18 in the central area of the shelfback sheet 11 as shown in FIG. 9(a). In this instance, the divider 18 maintains the same span as represented by the thickness when the spinal end side 12 is measured.

The shelfback sheet 11 is folded along the lines drawn by the divider 18, and brought to be attached to the spinal end side 12 of the laminated sheet papers 10.

In this instance, the shelfback sheet 11 has a reverse side to which the adhesive is applied with the adhesive coated on the spinal end side 12, thus bonding the laminated sheet papers 10 to produce the booklet in the book-making equipment 1.

Upon truing up the spinal end side 12 of the laminated sheet papers 10 as shown in FIG. 10, the laminated sheet papers 10 is thrown between the pressure surfaces 20 through the abutment surfaces 38 with the book-making equipment 1 stood invertedly. The laminated sheet papers 10 permit the spinal side 16 to encounter the surface of the work table so as to make the spinal end side 12 uniform.

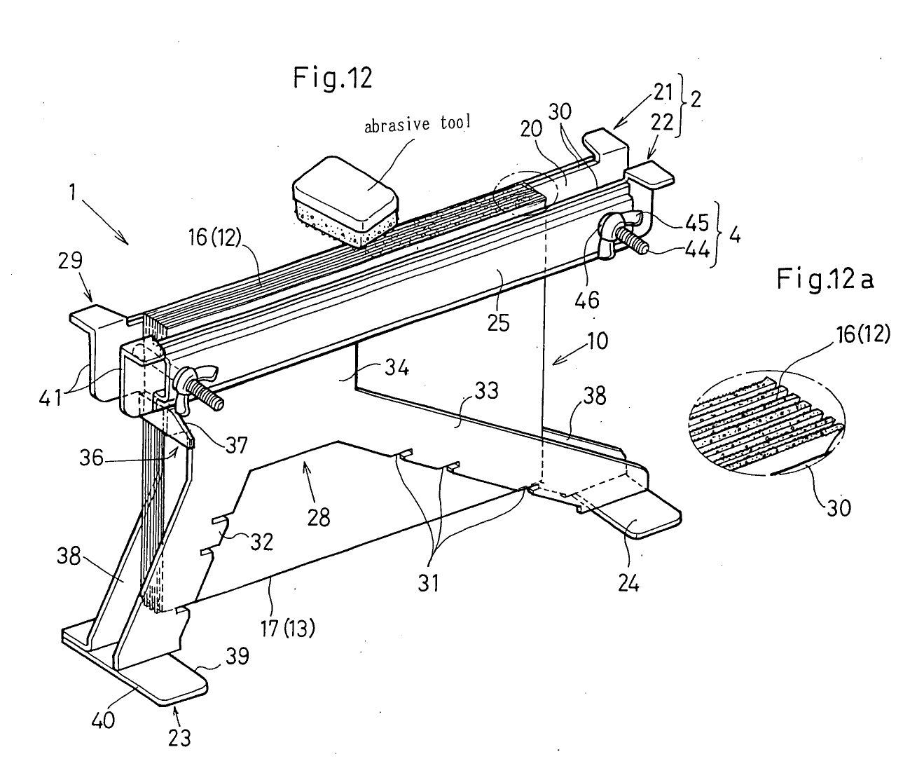

After clamping the spinal end side 12, the book-making equipment 1 is reverted back to the normal position as shown in FIGS. 12(a) and 12(b). With the spinal end side 12 thus made uniform, it is possible to set the extension length uniform without inviting uneven undulation on the spinal side 16. In this instance, the spinal side 16 is rubbed at its entire surface to bloat the spinal end side 12 in the laminated direction by means of an abrasive tool. As the abrasive tool, there includes a metallic file, a grinder, a brush, a pumice, a whetstone and the equivalent.

Upon bonding the laminated sheet papers of larger size (e.g., A3 lateral binding size), the laminated sheet papers 10 is thrown between the pressure surfaces 20 through the abutment surfaces 38 with the book-making equipment 1 stood invertedly so as to make the spinal end side 12 uniform. After clamping the spinal end side 12, the book-making equipment 1 is sidewisely turned by 90 degrees in the clockwise direction as shown in FIG. 11. In this situation, the book-making equipment 1 stands on the work table with the left side edges 40, 41 placed on the surface of the work table. Then, the adhesive is applied to the spinal side 16 which is roughened (ruffled) in advance.

Alternatively, the laminated sheet papers 10 may be thrown between the pressure surfaces 20 with the book-making equipment 1 turned by 90 degrees on the work table as shown in FIG. 11.

In this situation, the laminated sheet papers 10 permit its lower side end to rest on the side-end trimming portion 37 and the right side edge 39 of the main step portion 23. By pushing and tapping the spinal side 16 and the belly side 17, it is possbile to adjust the extension length, while at the same time, truing up the spinal end side 12 of the laminated sheet papers 10. Thereafter, the spinal end side 12 is clamped, and the spinal side 16 is manipulatively bloated by means of the abrasive tool.

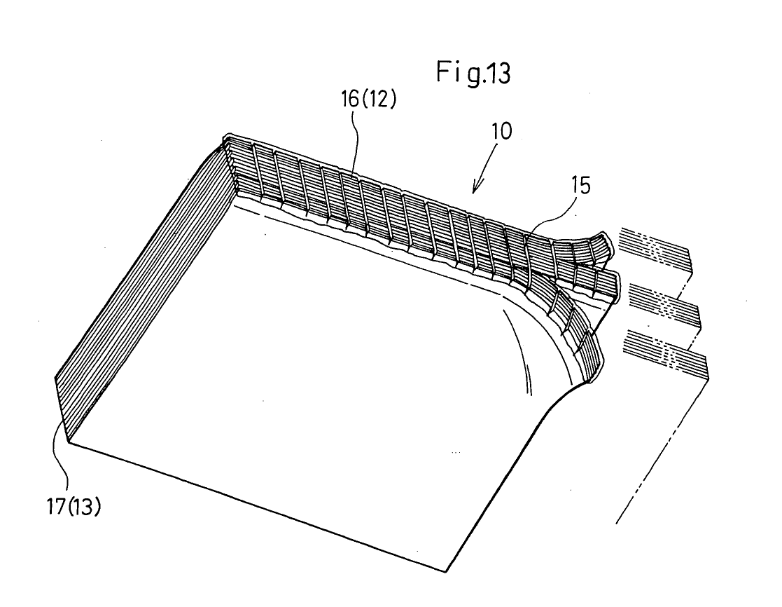

Alternatively, the laminated sheet papers may be joined together in correspondence to several booklets, and bonded at the spinal end side 12 integrally as shown in FIG. 13. The laminated sheet papers thus bonded may be divided into certain units of laminated sheet papers to produce several volumes of single booklets.

Advantages Obtained from the Present Embodiment

Upon throwing the laminated sheet papers 10 between the pressure surfaces 20 in the book-making equipment 1 placed perpendicular to the work table, the laminated sheet papers 10 permits the belly side 17 to encounter the belly-side trimming portion 35, the overside of thin plate 43 or the surface of the work table. This makes it possible to true up the belly end side 13 with the spinal end side 12 extended beyond the extension edge 30 by the predetermined length.

It is further possible to true up the spinal end side 12 by encountering the spinal side 16 against the work table with the book-making equipment 1 stood invertedly on the work table. The spinal end side 12 is clamped when extended beyond the extension edge 30 by the predetermined length.

In this way, the laminated sheet papers 10 permit the spinal end side 12 and the belly end side 13 to be trued up. This makes it easy to roughen the spinal end side 12, and eliminates the necessity of the time-consuming labor and the special skill to produce the booklet with a good appearance and bonding strength. By loosening the clamping member 4 to increase the hollow space between the pressure surfaces 20, it is possible to adjust and remove the laminated sheet papers 10.

The main leg piece 28 brings the abutment surface 38 into engagement with a part of the laminated sheet papers 10 except for its spinal end side 12, thus preventing the laminated sheet papers 10 from getting loose. This also makes it possible to prevent the laminated sheet papers 10 from being weighed down under the influence of the gravity when thrown between the pressure surfaces 20.

It is especially convenient to have the abutment surface 38 upon truing up the spinal end side 12 under the condition that the laminated sheet papers 10 are liable to weigh down because most of the laminated sheet papers 10 except for the spinal end side 12 are located above the pressure surfaces 20 as shown in FIG. 10.

The abutment surface 38 radially extends and comes in contact with a part of the laminated sheet papers 10 except for the spinal end side 12. Among the areas of the laminated sheet papers 10, areas are produced to be outside the contact with the abutment surface 38. These areas are no obstacles to true up the laminated sheet papers 10 because it is possible to neatly align the laminated sheet papers 10 by pushing and tapping the belly side 17 and the elevational end sides. This is especially useful when the size of the laminated sheet papers is altered before bonding them as shown in FIGS. 3, 4(a) and 10. This is because the pushing and tapping action enables the user to neatly align the laminated sheet papers 10 even when replacing the sizes of the laminated sheet papers 10 with smaller ones.

Based on the right side of the lug portion 36 protracted from the connection piece 34, the side-end trimming portion 37 is defined to engage with the left elevational side of the laminated sheet papers 10 so as to true up the elevational end. This makes it easy to neatly align the elevational side of the laminated sheet papers 10 with the spinal end side 12 clamped between the pressure surfaces 20.

With the thin plate 43 attached to the underside of the spacer 3, it is possible to adjust the extension length by the thickness of the thin plate 43 since the thin plate 43 adjustably changes a distance between the spinal end side 12 and the work table. This enables the user to adjust the extension length depending on the bonding strength, the thickness and characteristics of the laminated sheet papers 10 and characteristics of the adhesive.

With the lateral notches 31 defined along the short branch 32 and the long branch 33, it is possible to insert the spacer 3 into the corresponding pair of the lateral notches 31. Due to the spacer 3 inserted into the lateral notches 31, it is possible to maintain the extension length in correspondence to the laminated sheet papers 10 of A4, B5, A5 and B6 (vertical binding sizes) as shown in FIG. 4(b). By changing the spacer 3 to be inserted into the lateral notches 31, it is possible to alter the distance between the belly end side 13 and the work table. This makes it possible to not only make the booklet of the specified size (A4 vertical binding size) but also produce the booklet of other sizes (A4, B5, A5 and B6 vertical binding sizes).

The clutch pieces. 2 have a main support member 21 having the main step portions 23, 24 each provided to make the clutch pieces 2 stand on the work table. The movable piece 22 is supported by the main support member 21 and adapted to move toward and away from the main support member 21 upon adjusting the hollow space between the pressure surfaces 20.

With the main step portions 23, 24 placed on the work table, the clutch member 2 comes to stand on the work table. The clamping member 4 enables the user to push the movable piece 22 toward the main support member 21 so as to clamp the spinal end side 12 between the pressure surfaces 20.

This makes it possible to clamp the spinal end side 12 of the laminated sheet papers 10 with the clutch pieces 2 stood on the work table. In this situation, each of the main step portions 23, 24 extends toward and away from movable piece 22.

With the numerical relationship as defined by L/H≧1/20, it is possible to maintain the clutch pieces 2 stably standing on the work table upon clamping the laminated sheet papers 10 or doing other jobs on the work table. Where L is the distance in which the main step portions 23, 24 extend away from the movable piece 22, and H is a height of the book-making equipment 1.

With the spinal end side 12 extended beyond the extension edge 30 by the predetermined length when clamped between the pressure surfaces 20, it is possible to form the grooves 15 on the spinal side 16 by means of the serrated file 14. The spinal side 16 is further roughened (ruffled) at the grooves 15, and the spinal end side 12 is clamped with the adhesive applied to the roughened spinal side 16. This makes it possible to strongly bond neighboring sheets of the laminated sheet papers 10 through the adhesive.

With the roughened spinal side 16 tapped to permeate the adhesive between the laminated sheet papers after the adhesive is applied to the roughened spinal side 16, it is possible to deeply permeate the adhesive between the laminated sheet papers 10 so as to more increase the bonding strength of the spinal side 16 of the laminated sheet papers.

With the spinal side 16 clamped in such a direction as to depress the laminated sheet papers with the adhesive left in half-dried condition, it is possible to appropriately reduce the thickness of the spinal side 16 swollen due to the adhesive applied to it, while at the same time, increasing the bonding strength of the spinal side 16 of the laminated sheet papers 10.

### Modification Forms

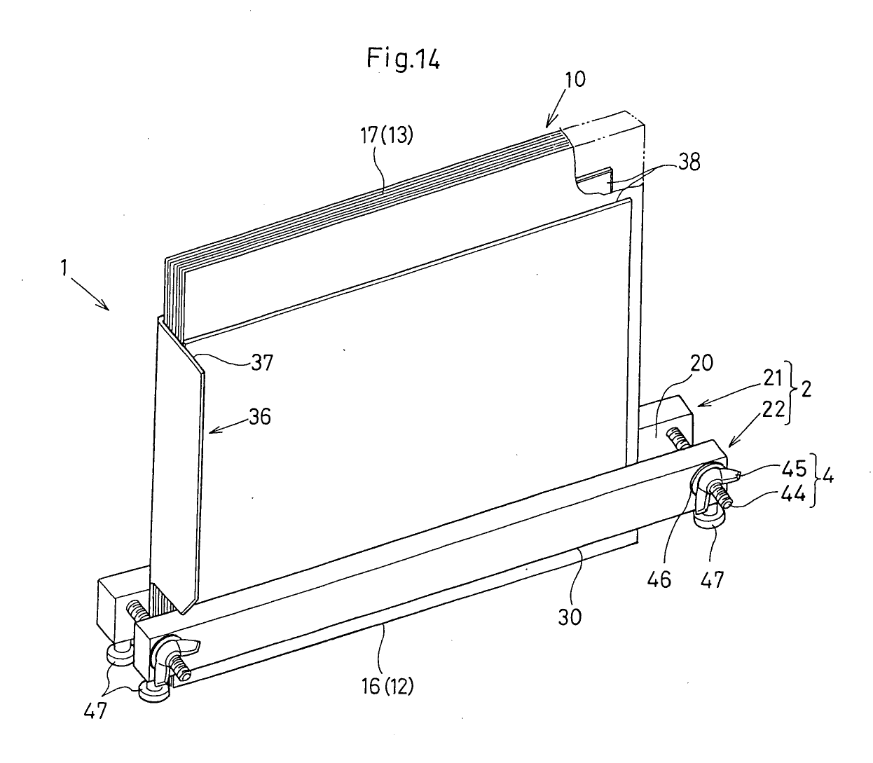

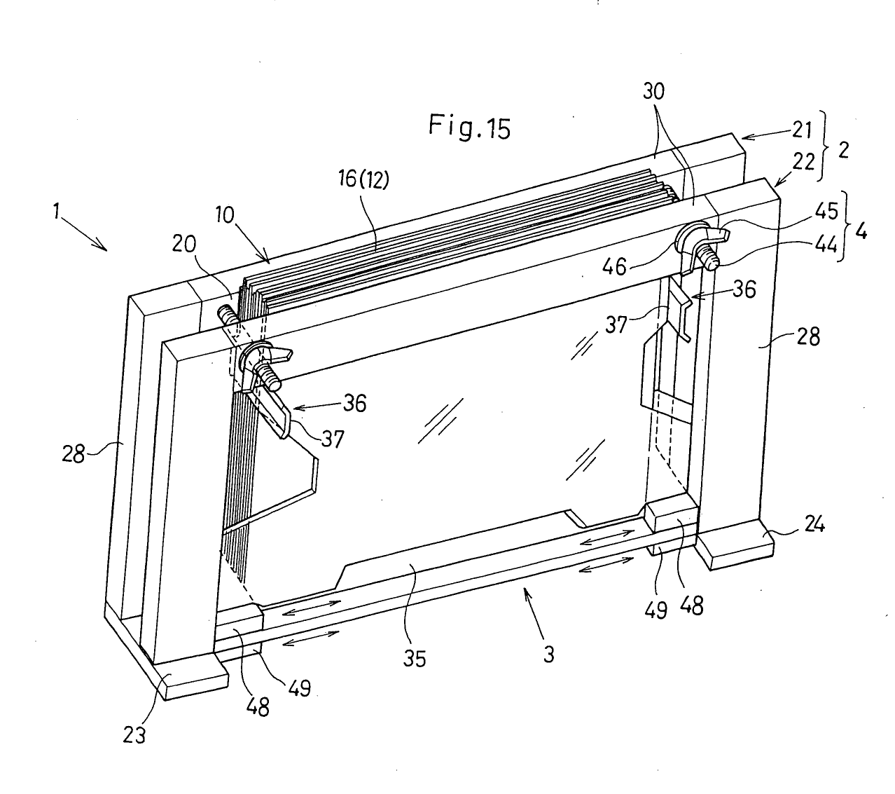

In the book-making equipment 1, the pushing member is provided by the spacer 3, the main leg piece 28 and the auxiliary leg piece 29, while the extension adjusting member provided by the thin plate 43. A foot screw 47 and a sash-like spacer may be used as the pushing member each as shown in FIG. 14 and 15.

The main support member 21 and the movable member 22 have screw hole (not shown) at the right and left portions as shown in FIG. 14. The foot screw 47 is adjustably tighten into the right and left screw holes. The laminated sheet papers 10 permit the spinal end side 12 to encounter the surface of the work table with the spinal end side 12 extended beyond the extension edge 30 by the predetermined length.

Turning the foot screw 47 makes it possible to change the distance between the pressure surfaces 20 and the work table upon adjusting the extension length. Further, the foot screw 47 serves as both the pushing member and the extension adjusting member. Slowly turning foot screw 47 enables the user to minutely adjust the extension length.

In order to serve as the slack-prevention member, the abutment surface 38 is shaped into a rectangular plate smaller than the specified size of the laminated sheet papers.

In FIG. 15, the sash-like spacer 3 is inserted between the main step pieces 23, 24 which have the belly-side trimming portion 35. Upon truing up the belly end side 13, the laminated sheet papers 10 permit the belly side 17 to encounter the belly-side trimming portion 35 with the spinal end side 12 extended beyond the extension edge 30 by the predetermined length.

On the right and left end sides of the spacer 3, there are provided a pair of opposed beams 48, 49. One pair of opposed beams 48 have a greater thickness directed upward, and another pair of opposed beams 49 have a smaller thickness directed downward. The spacer 3 serves as the pushing member, and the beams 48, 49 act as the extension adjusting member. Reversing the spacer 3 enables the user to adjust the extension length.

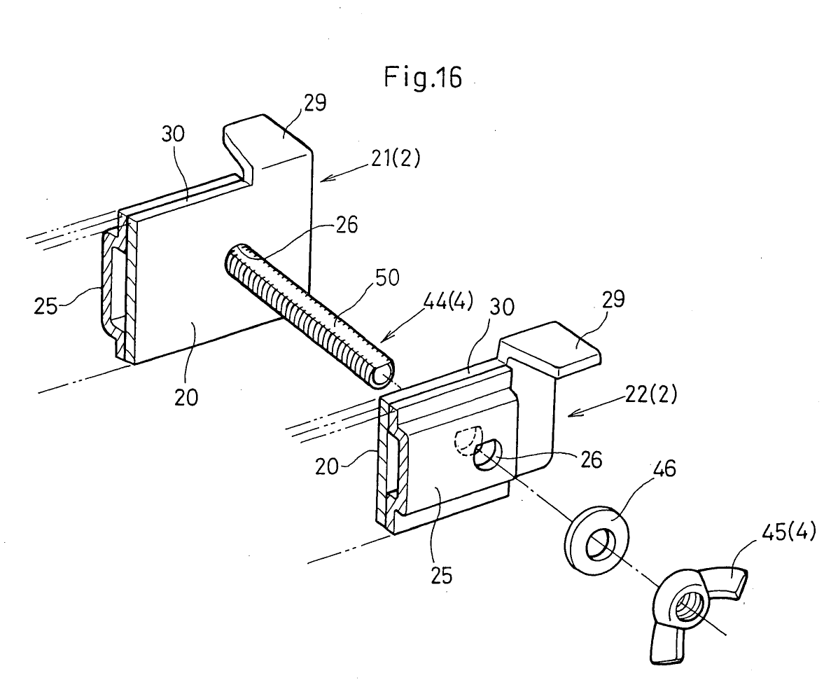

In the modification form as shown in FIG. 16, a flat surface 50 is provided with the screw 44 along its axial direction. The flat surface 50 helps reduce injuries given to the passage hole 26 and the screw 44 upon moving the movable member 22.

Several thin plates 43 may be prepared, and replaceably mounted on the spacer 3 to adjust the extension length in a multiple way.

In the book-making equipment 1, it is possible to bind two-folded sheet papers laminated in the thickness direction upon producing the booklet. With the use of the book-making equipment 1, it is possible to bind the two-folded sheet lamination by threads, and rounding the spinal side of the two-folded sheet lamination so as-to produce gorgeous booklets.

Upon binding the gorgeous booklets, it is possible to effectuate the slack-prevention member, the extension adjusting member, the sheet-size alteration member, and enabling the user to true up the spinal end side of the two-folded sheet lamination while standing the clutching members on the work table.

Instead of the radially bifurcated abutment surfaces 38, the abutment surfaces may be formed into lattice-work, triangular, rectangular or polygonal configuration. The abutment surfaces will do as long as they permit the outer force to exert against the belly side 17 and the elevational end side of the laminated sheet papers 10.

As for the sheet size, the size may be altered as desired without being confined to A4, B5, A5 and B6 vertical binding sizes. Instead of the screw 44 and the wing nut 45, a vice tool may be used as the clamping member 4. As the clamping member 4, a pneumatically, hydraulically or electrically driven power source may be employed to be linked to the pressure surfaces 20.

Instead of the spacer 3 and the lateral notches 31 provided as the sheet-size alteration member, a vertically movable plate may be provided which has a piece plate perpendicular to the pressure surfaces 20. A driven mechanism may be provided to actuate the vertically movable plate by means of the pneumatically, hydraulically or electrically driven power source.

With the use of these power sources, it is possible for manufacturers to mass produce the booklets as a book-making machine, although the book-making equipment 1 is basically supposed to be manually used by the individual users.

In this instance, it is unnecessary to sever the belly end side 13, the right and left elevational ends of the laminated sheet papers 10 upon truing the these ends of the laminated sheet papers 10 as opposed to the prior art counterpart. Namely, with the use of the present book-making equipment, it is possible to neatly true up the belly end side 13 and the right , left elevational ends of the laminated sheet papers 10, thus obviating the need of severing the belly end side 13 and the right , left elevational ends upon truing up them as opposed to the prior art counterpart.

### Industrial Applicability

The book-making equipment is useful for bonding one elevational end side of the laminated sheet papers upon producing the booklet, and substantially eliminates the necessity of the time-consuming labor and the special binding skill. For this reason, the book-making equipment is well-suited to make a relatively small number of booklets (several tens of volumes or less).

What is claimed is:

1. A book-making equipment in which a plurality of sheet papers are laminated, and one elevational end of the laminated sheet papers are bonded to produce a booklet;
said book-making equipment comprising;
a pair of clutch pieces placed perpendicular to a work table, said clutch pieces having corresponding planar pressure surfaces longer than said elevational end of the laminated sheet papers so as to releasably hold said one elevational end of the laminated sheet papers between said clutch pieces;
a clamping member provided to adjustably decrease a space between said pressure surfaces so as to clamp said one elevational end of said laminated sheet papers in such a direction as to depress said laminated sheet papers;
a pushing member provided to true up said one elevational end or the other elevational end of said laminated sheet papers and push said one elevational end out of said pressure surfaces by a predetermined length; and
a slack-prevention member provided to engage with other portion of said one elevational end so as to prevent said laminated sheet papers from getting loose.

2. The book-making equipment according to claim 1, wherein a side-triming member is provided to engage with an elevational end side formed between said one elevational end and other elevational end of said laminated sheet papers so as to confine said laminated sheet papers to true up said elevational end side of said laminated sheet papers.

3. The book-making equipment according to claim 1, wherein an extension adjustment member is provided to adjust a distance between said pressure surfaces and the surface of said work table, or to adjust a distance between said one elevational end of said laminated sheet papers and the surface of said work table so as to determine a length in which said one elevational end of said laminated sheet papers extends out of said pressure surfaces.

4. The book-making equipment according to claim 1, wherein a sheet-size alteration member is provided to adjust a distance between said one elevational end of said laminated sheet papers and the surface of said work table so as to produce booklets of different sizes.

5. The book-making equipment according to claim 1, wherein a pair of said clutch pieces further comprising:
a main support member having a main step portion provided to make said clutch pieces stand on said surface of said work table; and
a movable piece supported by said main support member and adapted to move toward and away from said main support member upon adjusting said space between said pressure surfaces.

6. The book-making equipment according to claim 5, wherein said main step portion extends away from said movable piece of said main support member as defined by L/H≧1/20.
Where L is a distance in which said main step portion extends away from said movable piece, and H is a height of said book-making equipment.

7. The book-making equipment according to claim 1 further comprising;
an extension adjustment member provided to adjust a distance between said pressure surfaces and the surface of said work table, or to adjust a distance between said one elevational end of said laminated sheet papers and the surface of said work table so as to determine a length in which said one elevational end of said laminated sheet papers extends out of said pressure surfaces;
a side-triming member is provided to engage with an elevational end side formed between said one elevational end and other elevational end of said laminated sheet papers so as to confine said laminated sheet papers to true up said elevational end side of said laminated sheet papers;
a sheet-size alteration member is provided to adjust a distance between said one elevational end of said laminated sheet papers and the surface of said work table so as to produce booklets of different sizes; and
a pair of said clutch pieces having a main support member having a main step portion provided to make said clutch pieces stand on said surface of said work table, and a movable piece supported by said main support member and adapted to move toward and away from said main support member upon adjusting said space between said pressure surfaces.

8. A book-making method using said book-making equipment according to claim 1 comprising steps of:
clamping one elevational end of said laminated sheet papers with said one elevational end extended beyond said pressure surfaces by a predetermined length;
roughening an elevational surface of said one elevational end extended beyond said pressure surfaces by means of a specified tool; and
applying an adhesive to said roughened elevational surface to bond said one elevational end of said laminated sheet papers.

9. The book-making method according to claim 8, wherein the roughened elevational surface is tapped to permeate said adhesive between said laminated sheet papers after said adhesive is applied to the roughened elevational surface.

10. The book-making method according to claim 8, wherein said one elevational end of said laminated sheet papers is clamped in such a direction as to depress said laminated sheet papers with said adhesive left in half-dried condition.
